(19) United States
(12) Patent Application Publication
(10) Pub. No.: US 2014/0379758 A1
(43) Pub. Date: Dec. 25, 2014

(54) APPARATUS AND METHOD FOR MANAGING EXPERIENCE INFORMATION OF DRIVER, AND SYSTEM THEREOF

(71) Applicant: Hyundai Motor Company, Seoul (KR)

(72) Inventors: Chul Min KIM, Suwon-si (KR); Suk Young RHO, Anyang-si (KR); Young Su KIM, Yongin-si (KR); Dong Youl LEE, Seoul (KR)

(73) Assignee: Hyundai Motor Company, Seoul (KR)

(21) Appl. No.: 14/098,332

(22) Filed: Dec. 5, 2013

(30) Foreign Application Priority Data
Jun. 25, 2013 (KR) 10-2013-0073134

(51) Int. Cl. G06F 17/30

(52) U.S. Cl. CPC G06F 17/30292
USPC 707/803; 707/812

(57) ABSTRACT

An apparatus and a method for managing experience information of a driver and a system thereof include an apparatus for managing experience information generating a contents file in a metamedia for the experience information of the driver and a vehicle by organically coupling vehicle manipulation data of the driver and each data acquired from the vehicle in correspondence with the manipulation data. A server classifies the contents file provided from the apparatus for managing experience information mounted in at least one vehicle depending on characteristics of the contents file, stores the classified contents file in a database (DB), and provides the contents file of a corresponding condition at the time of generating a sharing event.

### CROSS REFERENCE TO RELATED APPLICATION

This application claims the benefit of priority to Korean Patent Application No. 10-2013-0073134, filed on Jun. 25, 2013 in the Korean Intellectual Property Office, the disclosure of which is incorporated herein in its entirety by reference.

### TECHNICAL FIELD

The present disclosure relates to an apparatus and a method for managing experience information of a driver and a system thereof, and more particularly, to a technology of organically coupling vehicle manipulation information of a driver and output information of a vehicle so as to be managed as a contents file.

### BACKGROUND

In general, unique features of a vehicle may vary even in the same kind of vehicle due to driving pattern and preference of a driver. For example, an abrasion state and lifespan of vehicle parts, a learning logic of a controller, fuel efficiency, and the like, may change depending on the driving pattern and preference of a driver.

The driving pattern and preference of individual driver may serve as important factors which affect economical driving and safe driving as well as driving of other vehicles. Therefore, different experience information may be generated on the basis of the relationship between a driver and a vehicle and the different experience information may be utilized in various fields.

However, since the experience information is generated for each driver and each vehicle, it is difficult to manage information on big data and to reflect a change of information in real time.

### SUMMARY

The present disclosure has been made to solve the above-mentioned problems occurring in the prior art while advantages achieved by the prior art are maintained intact.

An aspect of the present disclosure provides an apparatus and a method for managing experience information of a driver to organically couple vehicle manipulation information of a driver and output information of a vehicle so as to be managed as a contents file, and a system thereof.

Another aspect of the present disclosure provides an apparatus and a method for managing experience information of a driver to facilitate steps of generating, reproducing, editing, and sharing the experience information of the driver by writing a contents file for the experience information of the driver using metalanguage, and a system thereof.

According to an exemplary embodiment of the present disclosure, an apparatus for managing experience information of a driver includes a data collector collecting vehicle manipulation data of the driver and data acquired from a vehicle and the vicinity of the vehicle in correspondence with the manipulation data. A user created experience (UCX) generator generates a contents file in a metamedia for the experience information of the driver and the vehicle by organically coupling each collected data. A UCX storage stores the contents file generated for the driver and the vehicle.

The UCX generator may call a UCX generation schema implementing an algorithm depending on a predefined file generation rule for the contents file through an external plug-in to match each collected data with the UCX generation schema.

The contents file may be written with a metalanguage.

The contents file may include a tag or metadata for at least one of time, location, and relationship of each collected data.

The contents file may be generated as an individual data type or a set type of plural data depending on the tag or the metadata.

The apparatus for managing experience information of a driver may further include a UCX editor calling and analyzing the contents file pre-stored in the UCX storage and applying and editing the data collected by the vehicle data collector to the called contents file.

The apparatus for managing experience information of a driver may further include a UCX reproducer calling and analyzing the contents file pre-stored in the UCX storage and writing a message based on an analysis result of the contents file and outputting the written message through an external interface.

At the time of analyzing the called contents file, a UCX analysis schema implementing an analysis algorithm of a file structure of the contents file may be called through an external plug-in to match the corresponding contents file.

The external interface may be connected to at least one of each unit, an external vehicle, an external terminal, and an external server.

According to another exemplary embodiment of the present disclosure, a method for managing experience information of a driver includes collecting vehicle manipulation data of the driver and data acquired from a vehicle and the vicinity of the vehicle in correspondence with the manipulation data. A contents file is generated in a metamedia for the experience information of the driver and the vehicle by organically coupling each collected data. The generated contents file is stored for the driver and the vehicle.

The method for managing experience information of a driver may further include calling and analyzing the stored contents file at the time of generating an editing event of the stored contents file. The collected data is applied to the called contents file and edited.

The method for managing experience information of a driver may further include calling and analyzing the stored contents file at the time of generating a reproducing event of the stored contents file. A message is written based on an analysis result of the contents file, and the written message is output through an external interface.

According to another exemplary embodiment of the present disclosure, a is system for managing experience information of a driver includes an apparatus for managing the experience information which generates a contents file in a metamedia for the experience information of the driver and a vehicle by organically coupling vehicle manipulation data of the driver and each data acquired from the vehicle in correspondence with the manipulation data. A server classifies the contents file provided from the apparatus for managing the experience information mounted in at least one vehicle depending on characteristics of the contents file, stores the classified contents file in a database (DB), and provides the contents file of a corresponding condition at the time of generating a sharing event.

The system for managing experience information of a driver may further include a sharing means receiving the contents file from at least one of the apparatus for managing the experience information and the server to share the information included in the contents file.

### BRIEF DESCRIPTION OF THE DRAWINGS

The above and other objects, features and advantages of the present disclosure will be more apparent from the following detailed description taken in conjunction with the accompanying drawings.

FIG. 1 is a diagram illustrating a configuration of a system to which an apparatus for managing experience information of a driver according to an exemplary embodiment of the present disclosure is applied.

FIG. 2 is a block diagram illustrating an apparatus for managing experience information of a driver according to an exemplary embodiment of the present disclosure.

FIG. 3 is a block diagram illustrating a detailed configuration of a UCX generator of FIG. 2.

FIG. 4 is a block diagram illustrating a detailed configuration of a UCX editor of FIG. 2.

FIGS. 5A and 5B are a block diagram illustrating a detailed configuration of a UCX reproducer of FIG. 2.

FIGS. 6 and 7 are exemplified diagrams referenced for describing a structure of the UCX file applied to an exemplary embodiment of the present disclosure.

FIG. 8 is a block diagram illustrating a server applied to an exemplary embodiment of the present disclosure.

FIG. 9 is a flow chart illustrating an operation flow of a method for managing experience information of a driver according to an exemplary embodiment of the present disclosure.

### DETAILED DESCRIPTION

Hereinafter, exemplary embodiments of the present disclosure will be described with reference to the accompanying drawings.

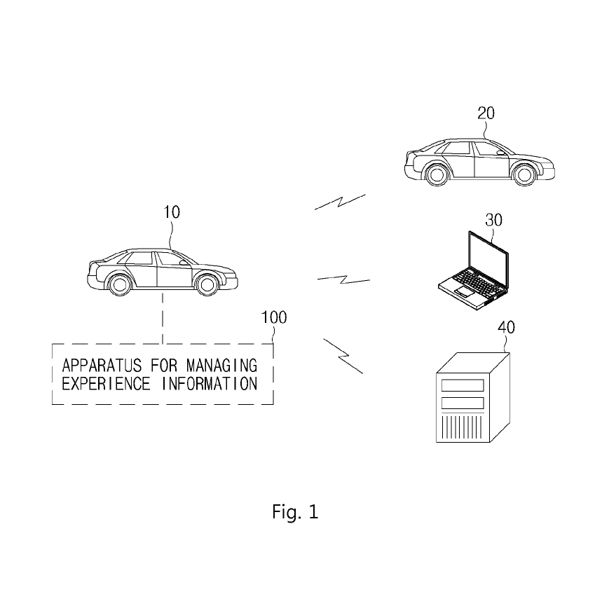

FIG. 1 is a diagram illustrating a configuration of a system to which an apparatus for managing experience information of a driver according to an exemplary embodiment of the present disclosure is applied. Referring to FIG. 1, the system for managing experience information of a driver according to an exemplary embodiment of the present disclosure may include an apparatus for managing experience information 100 which is equipped in a vehicle 10 and other vehicles 20, external terminals 30, a server 40, and the like, which are connected to the apparatus for managing experience information 100.

In this case, the apparatus for managing experience information 100 may collect the experience information of a driver and the vehicle 10, for example, manipulation data of the driver and data acquired from the vehicle 10 or the vicinity of the vehicle in correspondence with the manipulation data to generate the corresponding driver and the experience information of the vehicle 10 as a contents file.

Since the contents file for the experience information is written with a metalanguage as a metamedia, for example, an extensible markup language (XML), generation and editing thereof is facilitated, thereby making file management more convenient.

The apparatus for managing experience information 100 may share the contents file for the experience information of the driver and the vehicle 10 with another sharing means through an external interface. In this case, the apparatus for managing experience information 100 may provide the contents file through communication connection with other vehicles 20, the external terminals 30, the server 40, and the like. Further, the apparatus for managing experience information 100 may well receive the contents file stored in the sharing means through the external interface.

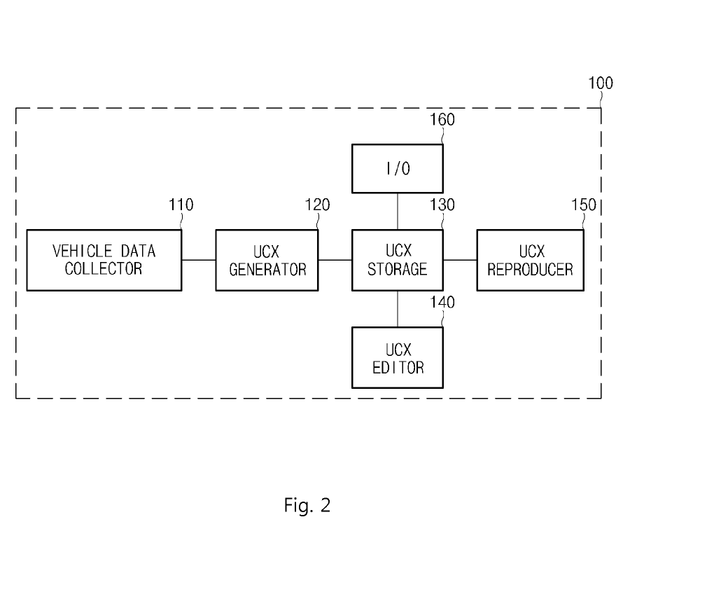

Therefore, the configuration of the apparatus for managing experience information 100 will be described in more detail with reference to FIGS. 2 to 5. However, in the following exemplary embodiments, for convenience of explanation, the experience information is called ‘user created experience (UCX)’ and the contents file is called a ‘UCX file’.

FIG. 2 is a block diagram illustrating the apparatus for managing experience information of a driver according to an exemplary embodiment of the present disclosure. Referring to FIG. 2, the apparatus for managing experience information 100 according to an exemplary embodiment of the present disclosure includes a vehicle data collector 110, a UCX generator 120, a UCX storage 130, a UCX editor 140, a UCX reproducer 150, an input/output interface (I/O) 160.

The vehicle data collector 110 collects input/output data of each unit and collects data acquired from the vicinity of the vehicle 10. In particular, the vehicle data collector 110 collects vehicle manipulation data, output data corresponding to the manipulation data, for example, raw data acquired from a power train, a chassis, a multimedia device, and an in-vehicle infotainment (IVI).

The UCX generator 120 organically couples each data collected by the vehicle data collector 110 to generate a UCX for a driver and the vehicle as a UCX file. The UCX file may be written in a metalanguage. In this case, the UCX generator 120 classifies each data according to a classification standard, for example, time, location, and relationship to organically coupled UCXs.

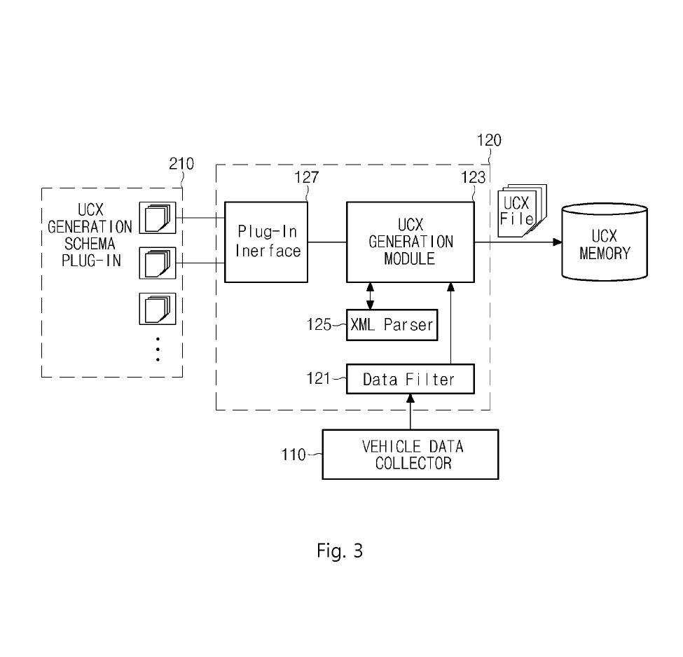

The UCX generator 120 may generate the UCX file by calling a UCX generation schema 210 which implements an algorithm depending on a predefined file generation rule for the contents file through an external plug-in and matching each collected data with the UCX generation schema 210. The detailed configuration of the UCX generator 120 will be described in detail with reference to an exemplary embodiment of FIG. 3.

The UCX storage 130 stores the UCX file generated by the UCX generator 120 and when there is a request, the UCX generator 120 calls and provides the corresponding UCX file. In this case, the UCX storage 130 may classify and store the UCX file depending on a UCX attribute, a layer, and the like, of the corresponding file. Further, the UCX storage 130 may also store the UCX file received from the outside through the external interface.

When an editing event for the UCX file stored in the UCX storage 130 is generated, the UCX editor 140 calls the UCX file to be edited in the UCX storage 130. In this case, the UCX editor 120 may analyze the corresponding UCX file by calling a UCX analysis schema 220 which implements an analysis algorithm for a file structure of the UCX file through the external plug-in and matching the called UCX file with the UCX analysis schema 220.

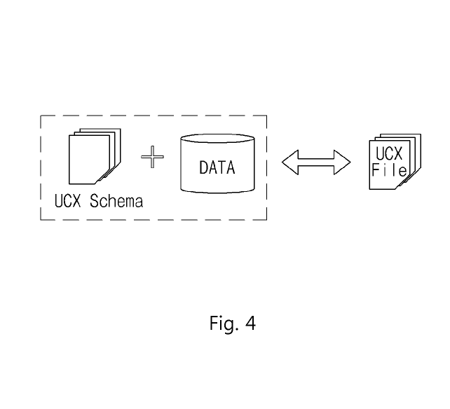

The UCX editor 140 may edit the corresponding UCX file based on the analysis result of the called UCX file. Herein, the UCX editor 140 may call the UCX generation schema 210 at the time of editing the UCX file and generate the edited UCX file based on the analysis result and the input editing information of the corresponding UCX file. The UCX file edited by the UCX editor 140 is again stored in the UCX storage 120. The detailed configuration of the UCX editor 140 will be described in detail with reference to an exemplary embodiment of FIG. 4.

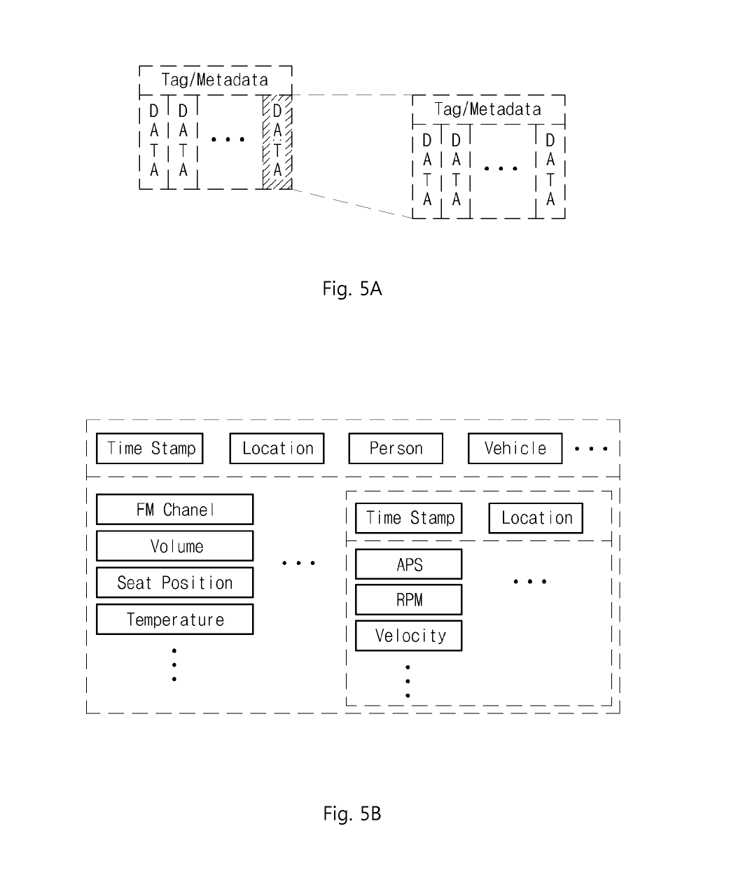

The UCX reproducer 150 calls and outputs the UCX file stored in the UCX storage 130 and writes a message based on the analysis result for the UCX file and outputs the written message through the external interface. As an example, the UCX reproducer 150 may output the corresponding message to a vehicle controller which is connected to a vehicle control interface, a multimedia device which is connected to an HMI interface, and external device which is connected to an external output interface. The detailed configuration of the UCX reproducer 150 will be described in detail with reference to an exemplary embodiment of FIG. 5.

FIG. 3 is a block diagram illustrating a detailed configuration of a UCX generator 120 of FIG. 2. Referring to FIG. 3, the UCX generator 120 includes a data filter 121, a UCX generation module 123, an XML parser 125, and a plug-in interface 127.

The data filter 121 outputs a query requesting data required to generate the UCX file to the vehicle data collector 110 to allow the vehicle data collector 110 to collect vehicle data. When the vehicle data is input from the vehicle data collector 110 in correspondence with the output query, the input vehicle data are filtered. The data collected by the vehicle data collector 110 are directly input to the data filter 121 and may be stored in a temporary repository and then input to the data filter 121. The data filter 121 transfers the filtered vehicle data to the UCX generation module 123.

The UCX generation module 123 connects to the plug-in of the UCX generation schema 210 through the plug-in interface 127 to generate the UCX file based on the vehicle data input from the data filter 121 and calls the UCX generation schema 210 therethrough.

The UCX generation schema 210 for implementing an algorithm depending on the predefined file generation rule for the contents file is an external application module in the plug-in type which may be added or deleted. The file generation rule, which is defined in the UCX generation schema 210, may change. As illustrated in FIG. 5A, the UCX generation module 123 generates the UCX file written with the metalanguage depending on the file generation rule defined in the UCX generation schema 210 by matching the input vehicle data with the called UCX generation schema 210.

Referring to FIG. 5B, the UCX generation module 123 generates one UCX file by classifying each collected vehicle data depending on time, location, and relationship of organically coupling each classified data. As illustrated in FIGS. 5A and 5B, a tag or metadata for at least one of the time, the location, and the relationship may be inserted into the generated UCX file, and the generated UCX is file may be generated as an individual data type or a set type of plural data depending on the organic coupling relationship of each data.

Herein, the tag or the metadata inserted into the UCX file may be analyzed and recognized by an XML parser 125.

At least one UCX file generated by the UCX generation module 123 is stored in the UCX storage 130.

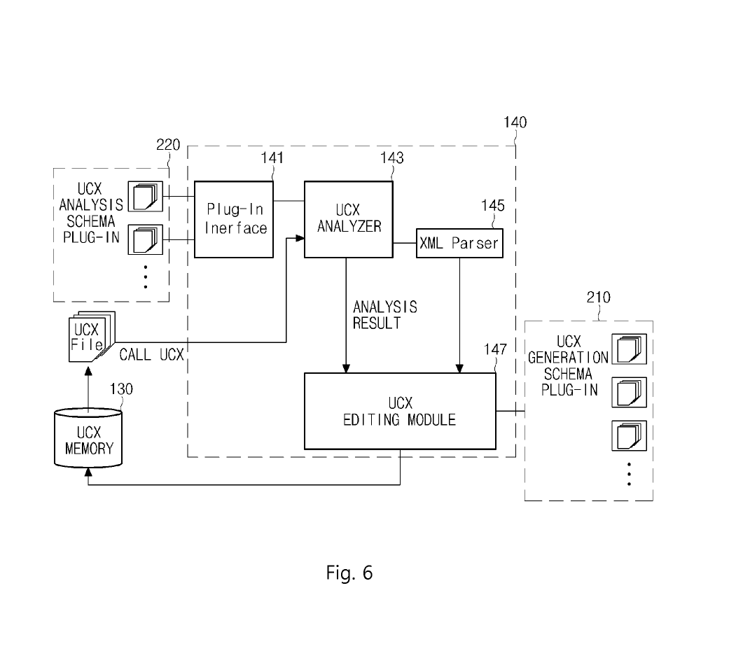

FIG. 6 is a block diagram illustrating a detailed configuration of the UCX editor 140 of FIG. 2. Referring to FIG. 6, the UCX editor 140 includes a plug-in interface 141, a UCX analyzer 143, an XML parser 145, and a UCX editing module 147.

When the editing event for the UCX file stored in the UCX storage 130 is generated, the UCX analyzer 143 calls the corresponding UCX file from the UCX storage 130. Further, the UCX analyzer 143 attempts the connection to the plug-in of the UCX analysis schema 220 through the plug-in interface 141 to edit the corresponding UCX file and calls the UCX analysis schema 220 therethrough.

The UCX analysis schema 220 is an external application module which implements the analysis algorithm for the file structure of the UCX file. Likewise the UCX generation schema 210, the UCX analysis schema 220 is an application module in the plug-in type which may be added or deleted.

The UCX analyzer 143 analyzes the UCX file by matching the corresponding UCX file with the UCX analysis schema 220 and provides the analysis result of the corresponding UCX file to the UCX editing module 147. The XML parser 145 analyzes and recognizes the tag or the metadata which is inserted into the UCX file written with the XML.

In this case, the UCX editing module 147 calls the UCX generation schema 210 and generates the UCX file edited by applying the analysis result of the corresponding UCX file and the information input for editing to the called UCX generation schema 210. Herein, the UCX file edited by the UCX editing module 147 is stored in the UCX storage 130.

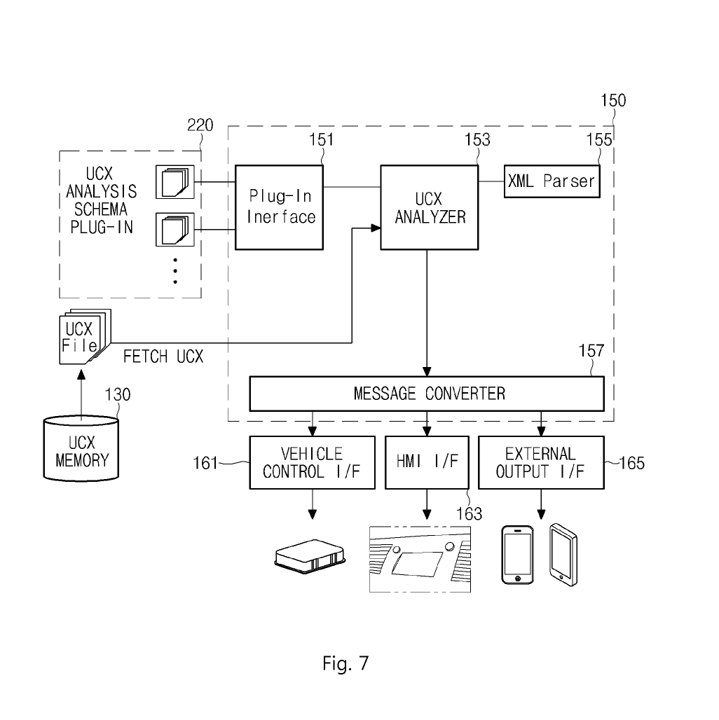

FIG. 7 is a block diagram illustrating a detailed configuration of a UCX reproducer 150 of FIG. 2. Referring to FIG. 7, the UCX reproducer 150 includes a plug-in interface 151, a UCX analyzer 153, an XML parser 155, and a message converter 157.

When the reproducing event for the UCX file stored in the UCX storage 130 is generated, the UCX analyzer 153 calls the corresponding UCX file from the UCX storage 130. Further, the UCX analyzer 153 attempts the connection to the plug-in of the UCX analysis schema 220 through the plug-in interface 151 to reproduce the corresponding UCX file and calls the UCX analysis schema 220 therethrough.

The UCX analysis schema 220 is an external application module which implements the analysis algorithm for the file structure of the UCX file. Likewise the UCX generation schema 210, the UCX analysis schema 220 is also an application module in a plug-in type which may be added or deleted.

The UCX analyzer 153 analyzes the UCX file by matching the corresponding UCX file with the UCX analysis schema 220 and provides an analysis result of the corresponding UCX file to the message converter 157. The XML parser 155 analyzes and recognizes the tag or the metadata which is inserted into the UCX file written with the XML.

The message converter 157 converts a message into an external executable message based on the analysis result of the corresponding UCX file and outputs the converted message through at least one of a vehicle control interface, an HMI interface, and an external output interface.

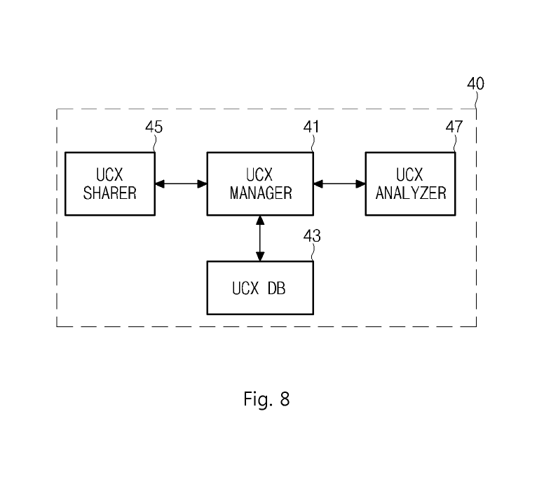

FIG. 8 is a block diagram illustrating a server applied to an exemplary embodiment of the present disclosure. Referring to FIG. 8, the server 40 according to an exemplary embodiment of the present disclosure includes a UCX manager 41, a UCX storage DB 43, a UCX sharer 45, and a UCX analyzer 47. The UCX manager 41 controls an operation of each unit of the server, stores a UCX file transmitted to the server in the UCX storage DB 43, and manages the stored UCX file.

The UCX sharer 45 receives the UCX file stored in the UCX storage DB 43 from outside or provides the UCX file stored in the UCX storage DB 43 to share the UCX file. In this case, the UCX sharer 45 may share the UCX file by being connected to external sharing means, for example, a vehicle and a multimedia device, and the like, by a peer to peer (P2P) scheme and share the UCX file by a server-client scheme. In addition, any scheme which may share the UCX file may be used.

The UCX analyzer 47 analyzes the UCX file transmitted to the server. In detail, the UCX analyzer 47 may analyze an information type of the each UCX file, and the like. Therefore, when the sharing event is input to the UCX file of a specific condition, the UCX manager 41 may provide the corresponding UCX file through the UCX sharer 45 by extracting the UCX file corresponding to the requested conditions based on the analysis result of the UCX analyzer 47.

As an example, the UCX manager 41 may extract the UCX file corresponding to the requested condition by figuring out a UCX pattern, statistical information (normal distribution, average, UCX ranking, and the like), and classification information (segment, age, sex, geography, time, path, and the like) and may provide the extracted UCX file to the external sharing means.

An operation flow of the apparatus for managing experience information 100 of a driver according to an exemplary embodiment of the present disclosure configured as described above will be described below in detail.

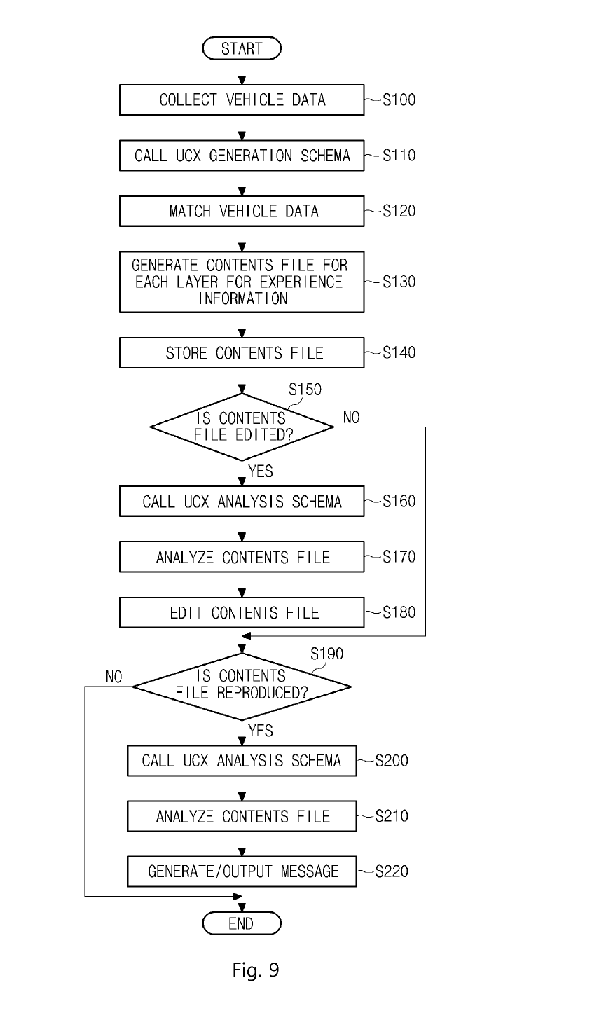

FIG. 9 is a flow chart illustrating an operation flow of a method for managing experience information of a driver according to an exemplary embodiment of the present disclosure. As illustrated in FIG. 9, the apparatus for managing experience information 100 collects the vehicle data including the vehicle manipulation data of a driver and the output data corresponding to the manipulation data to generate the UCX file (S100) and calls the UCX generation schema 210 through the external plug-in (S110). In this case, the UCX files for each layer for the UCX are generated (S130) by matching (S120) the vehicle data collected during step ‘S100’ with the UCX generation schema 210 called during step ‘S110’ and the UCX file generated during step ‘S130’ is stored (S140).

Thereafter, at the time of generating the editing event for the UCX file stored during step ‘S140’ (S150), the apparatus for managing experience information 100 calls the UCX analysis schema 220 through the external plug-in (S160) to analyze the UCX file receiving a request of edition (S170) and edits the UCX file based on the analysis result during step ‘S170’ and the information input for edition (S180).

When generating the reproducing event for the UCX file stored during step ‘S140’ (S190), the apparatus for managing experience information 100 calls the UCX analysis schema 220 through the external plug-in (S200) to analyze the UCX file receiving a request of reproduction (S210), generates the message corresponding to the corresponding UCX file based on the analysis result during step ‘S210’, and outputs the generated message to the outside (S220).

According to the exemplary embodiments of the present disclosure, the experience information of a driver can be easily generated, reproduced, and shared by organically coupling the manipulation information of a vehicle and the output information of the vehicle so as to be managed as the contents file in the metamedia.

Although the apparatus and the method for managing experience information of a driver according to the exemplary embodiment of the present disclosure have been described with reference to the accompanying drawings, the present disclosure is not limited to the exemplary embodiment and the accompanying drawings disclosed in the present specification, but may be modified without departing from the scope and spirit of the present disclosure.

What is claimed is:

1. An apparatus for managing experience information of a driver, comprising:
a data collector collecting vehicle manipulation data of the driver and data acquired from a vehicle and the vicinity of the vehicle in correspondence with the manipulation data;
a user created experience (UCX) generator generating a contents file in a metamedia for the experience information of the driver and the vehicle by organically coupling each collected data; and
a UCX storage storing the contents file generated for the driver and the vehicle.

2. The apparatus according to claim 1, wherein the UCX generator calls a UCX generation schema implementing an algorithm depending on a predefined file generation rule for the contents file through an external plug-in to match each collected data with the UCX generation schema.

3. The apparatus according to claim 1, wherein the contents file is written with a metalanguage.

4. The apparatus according to claim 1, wherein the contents file includes a tag or metadata for at least one of time, location, and relationship of each collected data.

5. The apparatus according to claim 4, wherein the contents file is generated as an individual data type or a set type of plural data depending on the tag or the metadata.

6. The apparatus according to claim 1, further comprising:
a UCX editor calling and analyzing the contents file pre-stored in the UCX storage and applying and editing the data collected by the vehicle data collector to the called contents file.

7. The apparatus according to claim 1, further comprising:
a UCX reproducer calling and analyzing the contents file pre-stored in the UCX storage and writing a message based on an analysis result of the contents file and outputting the written message through an external interface.

8. The apparatus according to claim 6, wherein at the time of analyzing the is called contents file, a UCX analysis schema implementing an analysis algorithm of a file structure of the contents file is called through an external plug-in to match the corresponding contents file.

9. The apparatus according to claim 8, wherein an external interface is connected to at least one of each unit, an external vehicle, an external terminal, and an external server.

10. A method for managing experience information of a driver, comprising:
collecting vehicle manipulation data of the driver and data acquired from a vehicle and the vicinity of the vehicle in correspondence with the manipulation data;
generating a contents file in a metamedia for the experience information of the driver and the vehicle by organically coupling each collected data; and
storing the contents file generated for the driver and the vehicle.

11. The method according to claim 10, further comprising:
calling and analyzing the stored contents file at the time of generating an editing event of the stored contents file; and
applying and editing the collected data to the called contents file.

12. The method according to claim 10, further comprising:
calling and analyzing the stored contents file at the time of generating a reproducing event of the stored contents file;
writing a message based on an analysis result of the contents file; and
outputting the written message through an external interface.

13. A system for managing experience information of a driver, comprising:
an apparatus for managing experience information which generates a contents file in a metamedia for the experience information of the driver and a vehicle by organically coupling vehicle manipulation data of the driver and each data acquired from the vehicle in correspondence with the manipulation data; and
a server classifying the contents file provided from the apparatus for managing experience information mounted in at least one vehicle depending on characteristics of the contents file and storing the classified contents file in a database (DB) and providing the contents file of a corresponding condition at the time of generating a sharing event.

14. The system according to claim 13, further comprising:
a sharing means receiving the contents file from at least one of the apparatus for managing experience information and the server to share the information included in the contents file.

15. The apparatus according to claim 7, wherein at the time of analyzing the called contents file, a UCX analysis schema implementing an analysis algorithm of a file structure of the contents file is called through an external plug-in to match the corresponding contents file.

16. The apparatus according to claim 15, wherein the external interface is connected to at least one of each unit, an external vehicle, an external terminal, and an external server
